(19) United States
(12) Patent Application Publication
(10) Pub. No.: US 2015/0186027 A1
(43) Pub. Date: Jul. 2, 2015

(54) SYSTEM AND METHOD FOR GESTURE BASED COLOR CORRECTION

(71) Applicant: THOMSON LICENSING, Issy de Moulineaux (FR)

(72) Inventors: Brian GAFFNEY, Thousand Oaks, CA (US); Bruce Johnson, West Hills, CA (US); Michael David Most, Los Angeles, CA (US)

(21) Appl. No.: 14/141,583

(22) Filed: Dec. 27, 2013

(51) Int. Cl. G06F 3/0488; G09G 5/06; G06T 11/60; G06F 3/0484; G06T 11/00

(52) U.S. Cl. CPC G06F 3/04883; G06F 3/0484; G06T 11/001; G06T 11/60; G09G 5/06; G09G 2354/00; G09G 2320/0666; G09G 2320/0606; G06T 2200/24

(57) ABSTRACT

Color correction, based on operator gestures, is accomplished by first determining at least one point of contact (604) in a tracking area of an operator interface touched by an operator. Thereafter, a direction (606) and magnitude (608) of movement for each point of contact is determined in in response to operator movement. A best match gesture (610) is determined based on the number, direction, and magnitude of motion of the points of contact; and that best match gesture is translated (612) into a change to a color parameter value.

### TECHNICAL FIELD

The present invention generally relates to color correction and, more particularly, to systems and methods for adjusting color decision list color values.

### BACKGROUND

Modern color control using a color decision list (CDL) operates by controlling a set of variables that include offset, slope, and saturation. Existing control devices include physical wheels or track balls that an operator may rotate to change the variable values. On such a physical control panel, the operator will turn the knob, for example, clockwise or counterclockwise to increase or decrease to change a particular value, respectively. This motion does not afford the operator a natural feeling and does not provide a significant tactile response.

Software controls exist as well, such as in connection with tablet computers. Such applications mimic the controls available on the physical panels, such that a operator moves a finger along a graphical knob or wheel. While providing the convenience of a tablet, this solution requires the operator look at the device to locate the control and maintain contact with it. As a result, the operator will often find it difficult to adjust the color levels while looking at the output. Thus, rather than replicating the functionality of the physical panel, these software applications merely emulate the capability, but inherit the limitations of the physical control without maintaining its benefits.

### SUMMARY

A method for color correction includes the steps of (a) determining at least one point of contact in a tracking area of an operator interface touched by an operator (b) determining a direction and magnitude of movement for each point of contact in response to operator movement; (c) determining a best match gesture based on the number, direction, and magnitude of motion of the points of contact using a processor; and translating the best match gesture into a change to a color parameter value.

A system for color correction includes a operator interface configured to determine at least one or more points of contact in a tracking area touched by an operator; a gesture module comprising a processor configured to determine a direction and magnitude of movement for each point of contact in response to operator movement and to determine a best match gesture based on the number, direction, and magnitude of motion of the points of contact; and a parameter adjustment module configured to translate the best match gesture into a change to a color parameter value.

### BRIEF DESCRIPTION OF THE DRAWINGS

The teachings of the present invention can be readily understood by considering the following detailed description in conjunction with the accompanying drawings, in which:

FIG. 1 is a block diagram of a operator interface in accordance with the present principles;

FIG. 2 is a diagram of a gestural color control in accordance with the present principles;

FIG. 3 is a diagram of a gestural color control in accordance with the present principles;

FIG. 4 is a diagram of a gestural color control in accordance with the present principles;

FIG. 5 is a diagram of a gestural color control in accordance with the present principles;

FIG. 6 is a block/flow diagram of a method for gestural color correction in accordance with the present principles; and

FIG. 7 is a block diagram of a system for gestural color correction in accordance with the present principles.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF PREFERRED EMBODIMENTS

Embodiments of the present principles provide gestural controls for multi-touch tablet devices that allow an operator to manipulate color controls without looking at the device. As will be discussed in detail below, the present embodiments provide unambiguous gestural motions that correspond to specific actions and allow a operator to enter these gestures anywhere in a relatively large area, such that the operator can adjust the colors while watching how the output changes.

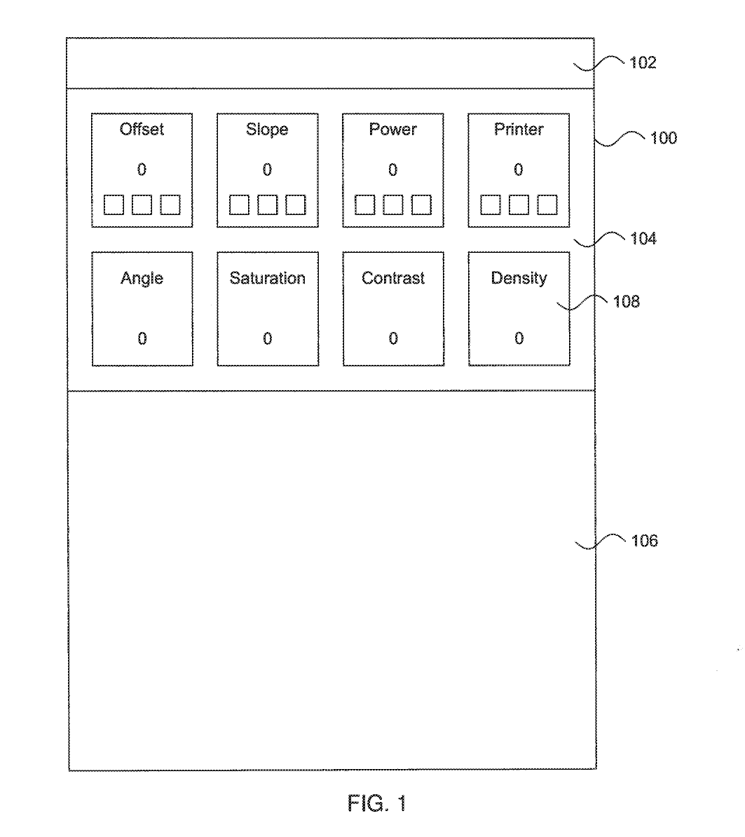

Referring now in specific detail to the drawings in which like reference numerals identify similar or identical elements throughout the several views, and initially to FIG. 1, an exemplary operator interface 100 is shown. It is contemplated that the operator interface 100 may occupy some or all of the available space on the screen of a physical computing display, such as the screen of a handheld tablet or touchscreen monitor.

The interface 100 is divided into a function/menu bar 102 that displays general information and allows the operator to access settings and menus. A parameter panel 104 includes a set of individual parameter controls 108, each of which displays one variable related to color control. The parameter controls 108 may allow direct entry of values via, for example, a keyboard or other input device. A tracking area 106 occupies a substantial part of the screen space.

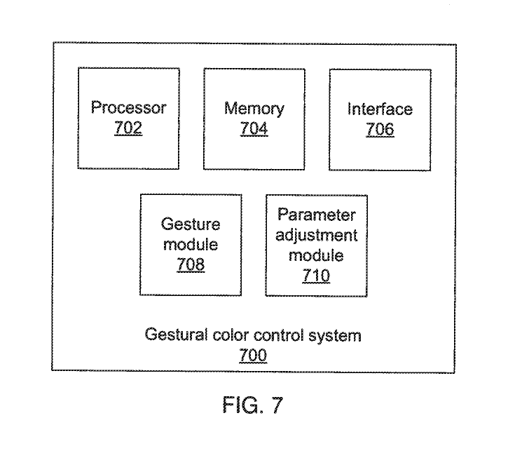

The tracking area 106 allows the entry of gesture control information by the operator. Because it occupies a significant amount of area, the operator can use the tracking area 106 without looking directly at the device. A processor 702 of FIG. 7 monitors the tracking area 106 of FIG. 1 to determine information about the operator's gestures, including the number of points of contact and their motion relative to one another.

To control color parameters, the operator simply applies any two fingers to touch the device's surface anywhere in the tracking area 106. Using different gestures, the operator can adjust different parameters without having to refer to the operator interface 100 for placement. The operator can then maintain visual contact with a measurement device, such as a vectorscope (not shown) to monitor how the color changes in response to the operator's controls. This allows for more precise color grading, because operator's attention is focused on the output color rather than on the interface.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and non volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

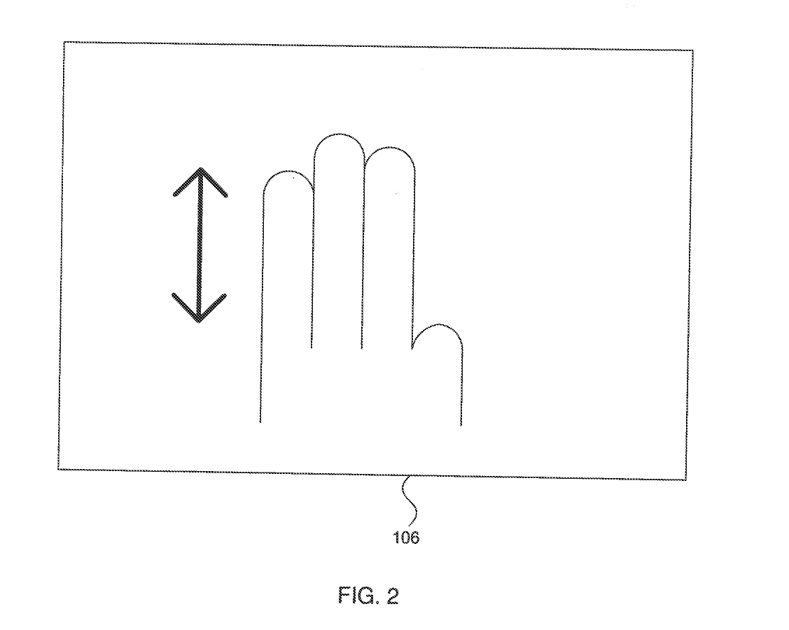

Referring now to FIG. 2, a first gesture control is shown. A operator uses, e.g., three fingers to swipe up or down on the tracking area 106. As the operator moves their fingers up, an associated color parameter value is increased, while moving the fingers down causes a decrease in the associated value. It is specifically contemplated that this gesture might be associated with adjusting an offset or lift value, but it should be understood that the function of these gestures may be reassigned between the different color parameters. The number of fingers involved may be left to the judgment of those having ordinary skill in the art, as described below.

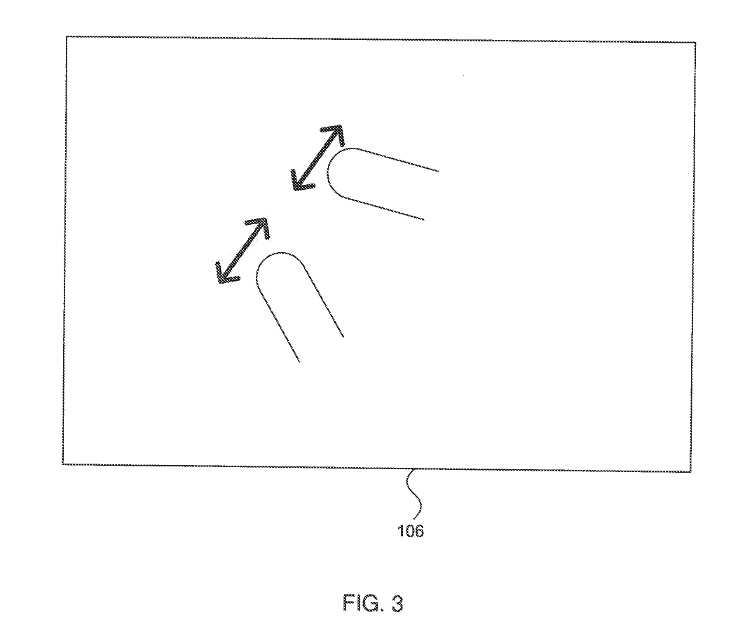

Referring now to FIG. 3, a second gesture control is shown. The operator touches the screen with two fingers and pinches the fingers together or spreads them apart. Pinching together may be associated with a decrease in an associated color parameter value, while spreading apart may be associated with an increase. It is specifically contemplated that this gesture may be associated with adjusting a contrast or gain value, but it should be understood that the function of this gesture may be reassigned to a different parameter value.

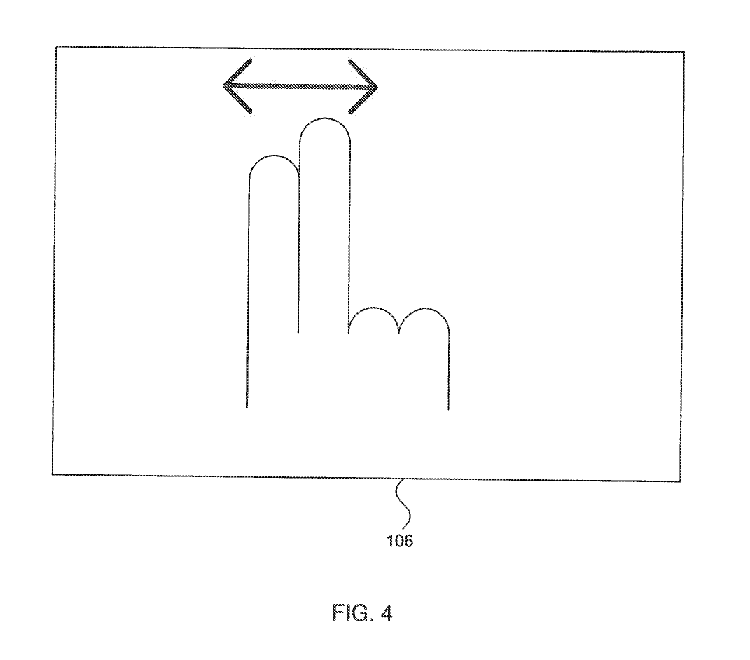

Referring now to FIG. 4, a third gesture control is shown. A operator uses, e.g., two fingers to swipe left or right on the tracking area 106. As the operator moves their fingers right, an associated color parameter value is increased, while moving the fingers left causes a decrease in the associated value. It is specifically contemplated that this gesture might be associated with adjusting a saturation value, but it should be understood that the function of these gestures may be reassigned between the different color parameters. The number of fingers involved may be left to the judgment of those having ordinary skill in the art, as described below.

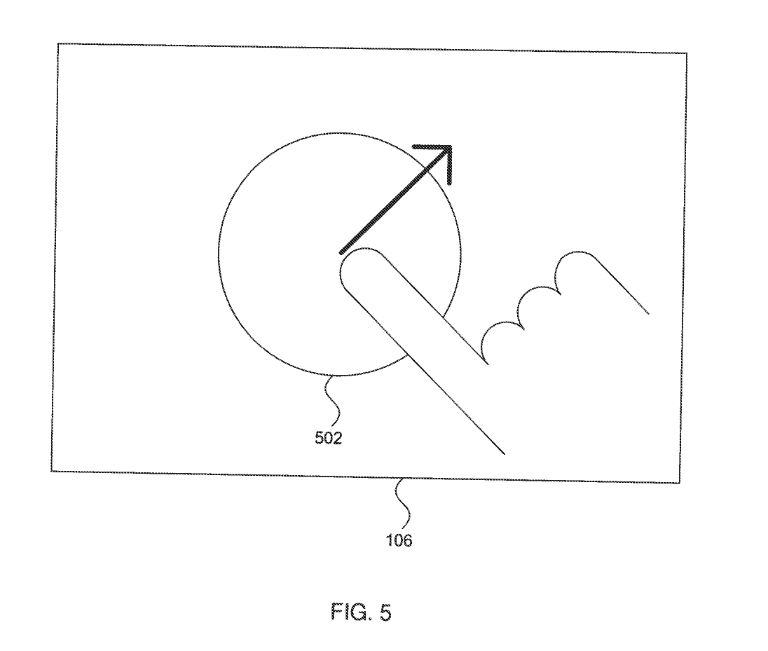

Referring now to FIG. 5, a fourth gesture control is shown. A operator uses, e.g., a single finger to create a vector along a vectorscope interface 502 in the tracking area 106. The vectorscope interface 502 may be displayed automatically upon contact by a single finger in the tracking area 502 and may include defined hue sections that represent, e.g., red, yellow, green, cyan, blue, and/or magenta. This allows a operator to select a color according to the direction of the vector along the vector scope.

A control in the function/menu bar 102, the parameter panel 104, or the tracking area 106 allows the operator to adjust a degree of control (e.g., fine, intermediate, coarse) and to set specific color channels (e.g., red, green, or blue) to be adjusted by the gestures in tracking area 106.

When entering gestures in the tracking area 106, the number of fingers employed may help determine which gesture is intended. Following the examples above, different numbers of fingers may be used for vertical swipes and for horizontal swipes. This makes the intended gesture unambiguous and avoids the possibility of misidentifying the gesture due to initial deviations from the intended direction. However, it is also contemplated that the same number of fingers may be used for these two gestures, allowing a operator to control both values simultaneously. Alternatively, the interface 100 may be configured to identify a gesture direction automatically according to a dominant direction after a pre-specified period of time. For example, if the operator's fingers have moved more downward than they have rightward after, e.g., half a second, the interface 100 may determine that the operator intended to enter a downward swipe.

The present invention may be incorporated in a standalone color correction product or may be used as a plugin or adjunct to an existing color correction software application. In the latter case, embodiments of the present invention would be configured to interface with such an application to replace or supplement existing color controls. In one example, system calls associated with touching the color control of the existing application may be intercepted to invoke a tracking area 106 as an overlay to the existing interface, allowing the operator to enter gestures that are then translated into commands in the existing interface. In this case, a separate gesture may be implemented to close the tracking area 106 and return the existing interface to its usual mode of operation.

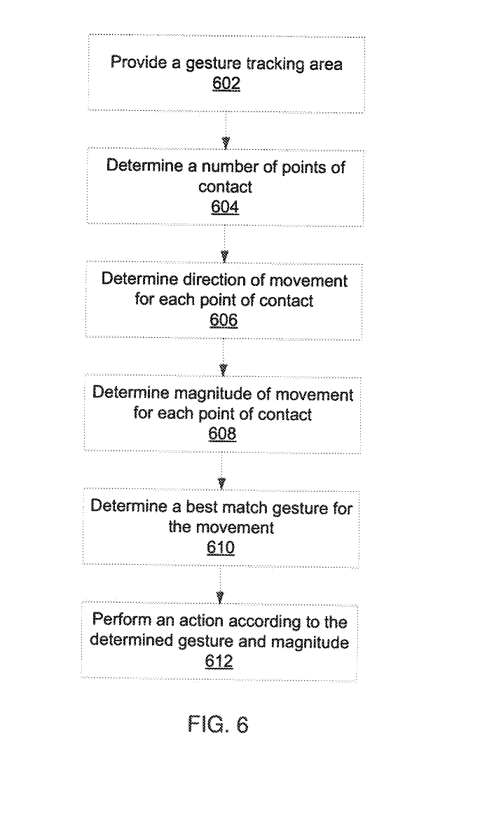

Referring now to FIG. 6, a block/flow diagram of a method for gestural color correction is shown. Block 602 provides a gesture tracking area 106. As described above, this may be integrated as part of a standalone application, or it may be accomplished by imposing a tracking area 106 over an existing interface.

Block 604 determines a number of points of contact. These points of contact represent, for example, individual fingertips in contact with the tracking area 106. Block 606 determines a direction of movement for each of the points of contact in response to operator movement and block 608 determines the magnitude of those movements. This information allows block 610 to determine a best match gesture. The number of points of contact and the direction (or relative direction) of the points of contact should be sufficient to determine which control is intended, and the magnitude of movement governs the magnitude of the change.

To find a best match gesture, block 610 may, for example, restrict out any gestures that have a number of points of contact different from that received from the tracking area 106 and then determine a likelihood score for each of the remaining gesture possibilities, selecting the gesture with the highest likelihood score. Block 612 performs the action represented by the determined gesture by adjusting the associated color parameter value by the indicated amount.

Referring now to FIG. 7, a gestural color control system 700 is shown. The system 700 includes the processor 702 described earlier and a memory 704. The memory 704 stores color parameter values, such as offset and saturation, making them available for alteration by the system 700. The system includes an interface 706. It is specifically contemplated that the interface 706 includes a graphical display with a touch interface, where the touch interface can recognize and track multiple points of contact.

A gesture module 708 receives information from the interface 706 regarding the positions of points of contact and their directions and uses the processor 702 to identify a gesture that fits the received information best. The gesture module 708 translates the gesture into a color parameter value and a degree and direction of change. Parameter adjustment module 710 then uses the information provided by the gesture module 708 to adjust the color parameter values stored in memory 704. The interface 706 updates any information displayed regarding the adjusted parameter values in accordance with the change.

Although not shown, the operator interface 106 could display a waveform pattern from a Waveform and Vectorscope, such as the Leader 5330 Waveform Device. The displayed waveform pattern would be a visual representation of the signal from a camera (not shown). Normally, that manipulation of a color correction device, such as the system of FIG. 7 affects the image on the monitor and the vectorscope of the primary color correction of the camera source material. By displaying this waveform pattern on in the operator interface 106, the user can simply adjust the waveform pattern, by using a single finger and grabbing points on the waveform pattern and moving them accordingly into the shape that best represents the primary color adjust desired.

Having described preferred embodiments for systems and methods for gesture based color correction (which are intended to be illustrative and not limiting), it is noted that modifications and variations can be made by persons skilled in the art in light of the above teachings. It is therefore to be understood that changes may be made in the particular embodiments of the invention disclosed which are within the scope of the invention as outlined by the appended claims. While the forgoing is directed to various embodiments of the present invention, other and further embodiments of the invention may be devised without departing from the basic scope thereof.

1. A method for color correction, comprising:
determining (604) at least one point of contact in a tracking area of an operator interface touched by an operator;
determining a direction (606) and magnitude (608) of movement for each point of contact in response to operator movement;
determining a best match gesture (610) based on the number, direction, and magnitude of motion of the points of contact using a processor; and
translating (612) the best match gesture into a change to a color parameter value.

2. The method of claim 1, wherein determining the best match gesture comprises detecting a gesture that includes a characteristic number of contact points and a magnitude of vertical displacement.

3. The method of claim 2, wherein the characteristic number of contact points is three and wherein the color parameter value is an one of an offset or lift value.

4. The method of claim 1, wherein determining the best match gesture comprises detecting a gesture that includes two contact points and a magnitude of one of an increase or decrease in a distance between the two contact points.

5. The method of claim 1, wherein determining the best match gesture comprises detecting a gesture that includes a characteristic number of contact points and a magnitude of horizontal displacement.

6. The method of claim 5, wherein the characteristic number of contact points is two and the color parameter value is saturation.

7. The method of claim 1, wherein determining the best match gesture comprises detecting a gesture that includes a single contact point, a displacement vector direction, and a displacement vector magnitude.

8. The method of claim 7, wherein translating the best match gesture into a change to a color parameter value comprises changing a hue in correspondence with the displacement vector direction.

9. The method of claim 8, wherein translating the best match gesture into a change to a color parameter value comprises changing a second color parameter value in correspondence with the displacement vector magnitude.

10. A system for color correction, comprising:
a operator interface (706) configured to determine one or more points of contact in a tracking area touched by an operator;
a gesture module (708) comprising a processor configured to determine a direction and magnitude of movement for each point of contact in response to operator movement and to determine a best match gesture based on the number, direction, and magnitude of motion of the points of contact; and
a parameter adjustment (710) module configured to translate the best match gesture into a change to a color parameter value.

11. The system of claim 10, wherein determining the best match gesture comprises detecting a gesture that includes a characteristic number of contact points and a magnitude of vertical displacement.

12. The system of claim 11, wherein the characteristic number of contact points is three and wherein the color parameter value is one of an offset or lift value.

13. The system of claim 10, wherein determining the best match gesture comprises detecting a gesture that includes two contact points and a magnitude of one of increase or decrease in a distance between the two contact points.

14. The system of claim 10, wherein determining the best match gesture comprises detecting a gesture that includes a characteristic number of contact points and a magnitude of horizontal displacement.

15. The system of claim 14, wherein the characteristic number of contract points is two and the color parameter value is saturation.

16. The system of claim 10, wherein determining the best match gesture comprises detecting a gesture that includes a single contact point, a displacement vector direction, and a displacement vector magnitude.

17. The system of claim 16, wherein translating the best match gesture into a change to a color parameter value comprises changing a hue in correspondence with the displacement vector direction.

18. The system of claim 17, wherein translating the best match gesture into a change to a color parameter value comprises changing a second color parameter value in correspondence with the displacement vector magnitude.

19. A non-transitory computer readable storage medium comprising a computer readable program for color correction, wherein the computer readable program when executed on a computer causes the computer to perform the steps of:
determine (604) at least one point of contact in a tracking area of an operator interface touched by an operator;
determining a direction (606) and magnitude (608) of movement for each point of contact in response to operator movement;
determining a best match gesture (610) based on the number, direction, and magnitude of motion of the points of contact using a processor; and
translating (612) the best match gesture into a change to a color parameter value.
